(19) United States
(12) Patent Application Publication
(10) Pub. No.: US 2019/0163002 A1
(43) Pub. Date: May 30, 2019

(54) APPARATUS AND METHOD OF MANUFACTURING FOR A SPORTS-RELATED WRITING TABLET

(71) Applicant: Jack Mai, Hacienda Heights, CA (US)

(72) Inventor: Jack Mai, Hacienda Heights, CA (US)

(21) Appl. No.: 16/206,978

(22) Filed: Nov. 30, 2018

Related U.S. Application Data
(60) Provisional application No. 62/592,978, filed on Nov. 30, 2017.

(51) Int. Cl. G02F 1/1333; G06F 3/041

(52) U.S. Cl. CPC G02F 1/13338; G06F 2203/04103; G06F 3/0414

(57) ABSTRACT

An approach for provided for an improved coaching board that includes an e-writer device having sports-field patterns placed upon it. The e-writer device may be written upon with a stylus or any other object that can places pressure on the e-writer surface. The coaching board can be implemented with diagrams that resemble courts, fields and swimming pools so coaches can draw plays, position players and write temporary notes.

### CROSS-REFERENCE TO RELATED APPLICATIONS

The present application claims the benefit of priority to U.S. Provisional No. 62/592,978, filed on Nov. 30, 2017, which is hereby incorporated by reference in its entirety.

### BACKGROUND

Dry-erase boards have become ubiquitous in the world of sports, where many sporting teams and coaches routinely use dry-erase boards before, during, and after games to map out strategies and plays for sporting endeavors. In many cases, dry-erase boards intended for sports are now being manufactured with lines and markings designed to mimic the field of play for the sport of interest.

In ordinary usage, the conventional dry-erase boards are used by employing an ink-based marker to write upon the board, with an eraser/cloth used to wipe/clean the board. The problem with this approach is that the marker will inevitably stain the board after multiple usages making it very difficult to wipe clean. Over time, the boards become stained to the point of being unusable. Indeed, due to this problem, it is well known that coaching whiteboards will often need to be replaced at least once every season, and often multiple times in a season if heavily used.

An additional problem with sports-intended dry-erase boards is that their functionality completely depends upon the ready availability of markers to mark the boards. If the markers are misplaced and/or run out of ink, then the dry-erase boards essentially becomes useless.

Moreover, the process of using erasers/cloths to wipe the boards is also problematic, since these erasers and cloths are an aggravation to use, constantly dirty, and become additional items that need to be carried around which can become misplaced or damaged.

Therefore, there is a need for an improved approach to implement writable surfaces for sports and coaching activities.

### SUMMARY

Disclosed is an improved approach to implement a coaching board that comprises an e-writer device having sports-field patterns placed upon it. The e-writer device may be written upon with a stylus or any other object that can places pressure on the e-writer surface. The inventive coaching board can be implemented with diagrams that resemble courts, fields and swimming pools so coaches can draw plays, position players and write temporary notes. The board can implement these diagrams without requiring paint on the screen, to avoid the problems of the paint that may cause the tablet to glitch and become non-operable. Instead, the overlay screen provides the field markings, while also serving to protect the underlying tablet screen.

Further details of aspects, objects, and advantages of some embodiments are described below in the detailed description, drawings, and claims. Both the foregoing general description and the following detailed description are exemplary and explanatory, and are not intended to be limiting as to the scope of the embodiments.

### BRIEF DESCRIPTION OF THE DRAWINGS

The drawings illustrate the design and utility of some embodiments of the present invention. It should be noted that the figures are not drawn to scale and that elements of similar structures or functions are represented by like reference numerals throughout the figures. In order to better appreciate how to obtain the above-recited and other advantages and objects of various embodiments of the invention, a more detailed description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1A illustrates an e-writer tablet device.

FIG. 1B illustrates an e-writer tablet device having sports patterns placed thereon.

FIG. 2 shows a side and partial cross-sectional view of a coaching board according to some embodiments of the invention.

FIG. 3 illustrates a flowchart of an approach to manufacture a coaching board according to some embodiments of the invention.

FIG. 4 illustrates an example approach to implement the overlay screen according to some embodiments.

FIG. 5 illustrates a process and equipment for laser engraving/marking a screen material according to some embodiments.

FIG. 6A illustrates a dark surface on an e-writer tablet device.

FIG. 6B illustrates the use of a label layer to colorize an e-writer tablet device.

### DETAILED DESCRIPTION

In the following description, numerous specific details are set forth to provide a more thorough description of the specific examples described herein. It should be apparent, however, to one skilled in the art, that one or more other examples and/or variations of these examples may be practiced without all the specific details given below. In other instances, well known features have not been described in detail so as not to obscure the description of the examples herein. For ease of illustration, the same number labels are used in different diagrams to refer to the same items; however, in alternative examples the items may be different.

As noted above, conventional dry-erase solutions for coaching boards suffer from a variety of problems. As such, there is a need for an improved approach to implement coaching boards.

Recently, there has been the introduction of electronic tablets into the marketplace for a variety of different purposes, including general purpose compute-based tablets such as Ipads and Android tablets. However, while these electronic tablets are adequate for many use cases for which they can be programmatically configured, they are not generally very useful for coaching activities. This is because general purpose electronic tablets, since they are in essence mini-computers, often require an excessive period of time and compute resources for boot-up and application start-up tasks, which may take too much time when coaching activities often require the coaching board to be used in very tight time windows during regulation time-out periods for various sports.

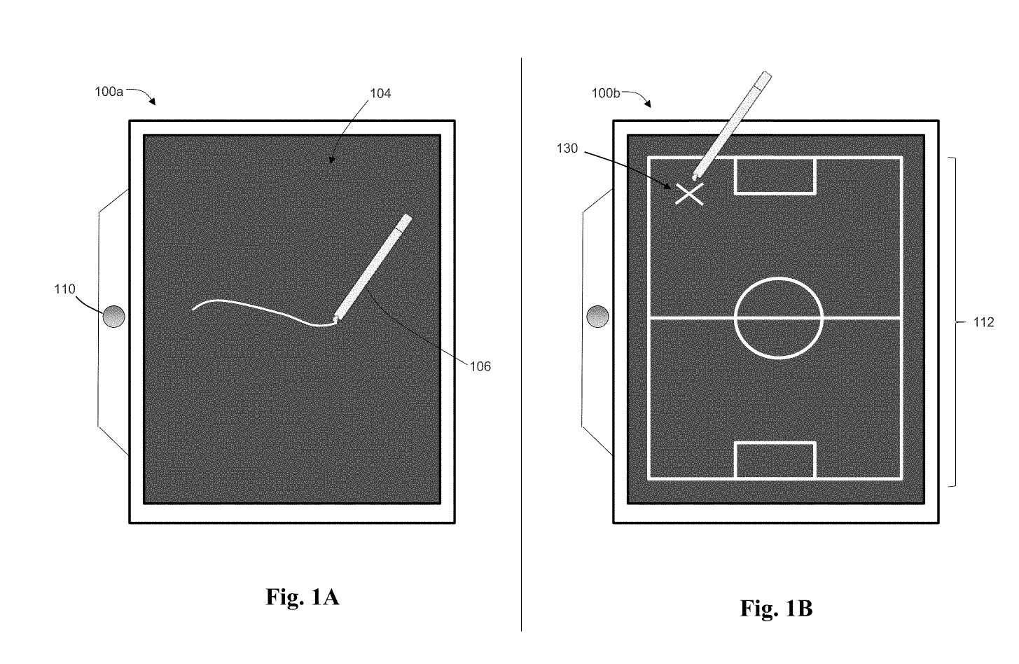

As shown in FIG. 1A, some embodiments of the invention pertain to electronic writing tablets 100a (also referred to as “ewriter tablets” or “ewriters” or “e-writers”), which are tablets that are specifically designed to receive writing input and to display those inputs as electronic markings on the tablet. Such tablets 100a often include an LCD (liquid crystal display) 104 having a pressure sensitive surface that converts pressure into an electrical and/or physical reaction that affects the display substrate materials of the LCD 104, such that the LCD displays markings corresponding to the pressure points on the LCD screen 104. For example, a stylus 106 may be employed to create text or drawings onto the LCD surface, which causes the liquid crystals to be ordered within the LCD display to display markings that correspond to the movements of the stylus 106 (or other object or instrument that may cause pressure on the LCD surface) over the surface of the LCD.

The markings on the LCD display will be retained in its displayed state due to the continued ordering of the liquid crystal molecules within the layers of the LCD device. However, a control device, such as button 110, can be provided to erase the markings on the LCD display. Manipulation of erasure button 110 controls/initiates an electric field within the tablet that arranges the molecules into its initial state such that the markings are erased. This provides a single button approach to erase all of the drawn/written markings on the entire screen.

FIG. 1B illustrates an ewriter tablet 100b having markings 112 representative of a playing field for a sports activity. This permits the user to use the stylus to write or draw onto the screen (such as drawing 130 that was created with the stylus), where the screen includes the permanent field marking 112.

In the current embodiment, the markings 112 are physically implemented and are permanently placed onto the tablet and/or tablet screen components, rather than being implemented purely through electronic display artifices that are programmatically configured. While purely electronic field markings implemented with software may be used in some circumstances, they tend to be less useful to a coach during gametime due to various problems, such as these electronic field markings being difficult to see in certain situations, as well as the display latency due to program application startup requirements.

Conventional technologies are unable to place permanent, physical markings, such as markings 112, onto tablets in a manner that makes them useful for coaching boards. For example, one non-optimal approach is to simply apply ink or paint to the surface of the tablet to impose the sports-related field markings. However, this approach suffers from many defects, including the fact that the paint/ink markings are detrimental to the ability for a user to smoothly and comfortably write onto the painted surface. In addition, the paint/ink markings may also interfere with the ability of the ewriter tablet to recognize the pressure applied by the stylus, which affects the ability of the tablet to display an image of the writing/drawing by the user.

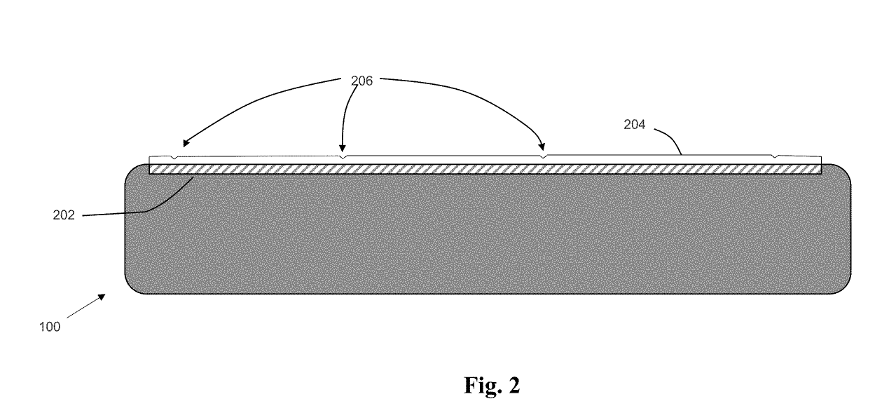

Embodiments of the invention provide an effective approach to implement field markings onto the tablet surface. FIG. 2 shows a side and partial cross-sectional view of a coaching board 100 according to some embodiments of the invention, where permanent field markings are attached to the tablet and/or tablet screen component. Here, the tablet 100 includes an LCD screen 202. Applied over the LCD screen 202 is an overlay layer 204 having permanently engraved/marked portions 206. In some embodiments, the overlay layer 204 comprises a transparent tempered glass screen, where the permanently engraved/marked portions 206 are formed using laser engraving/marking/etching processes.

The engraved/marked portions 206 changes the optical properties of those portions of the transparent overlay layer 204, such that they are visually perceptible to the eyes of the user. In particular, in some embodiments, the laser engraving/etching cuts into the screen material, which changes the reflective and/or refractive properties of the overlay surface. In some cases, the engraved/marked portions 206 appear with a white or grayish coloring, which is visually prominent when overlaid over a dark or black surface of the ewriter LCD screen.

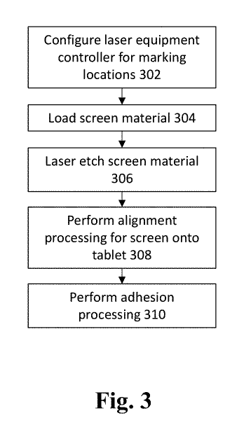

FIG. 3 illustrates a flowchart of an approach to manufacture a coaching board according to some embodiments of the invention. In some embodiments, the diagram markings on the overlay screen are formed using a laser-based engraving/marking process. Laser-engraving/marking equipment is employed to permanently sketch diagrams onto the overlay screen. Therefore, at step 302, the laser equipment is configured with the appropriate controller instructions to implement the desired engravings/markings onto the overlay screen. The scaled-down line drawing of a court, field or swimming pool are used to form the locations where the laser controller is configured to engrave/mark upon. These locations, as well as other pertinent laser equipment operational parameters, are programmed into the laser equipment.

At step 304, the screen material is loaded onto and/or into the laser equipment and/or feeder/loader. In some embodiments, the overlay screen comprises a tempered glass screen having multiple layers of screen material. The screen materials is intended to be flawless (e.g., sensitive to the touch), which adds strength to the screen and is transparent.

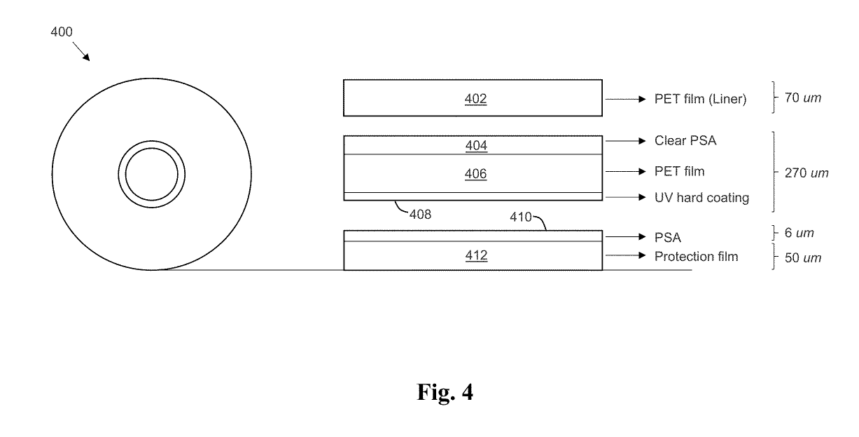

FIG. 4 illustrates an example approach to implement the overlay screen 400 according to some embodiments. The physical properties of the screen embodiment includes some or all of the following: (a) a liner film (Polyethylene terephthalate or PET) 402 having a standard specification for thickness of approximately 70+/−2 μm; (b) silicon PSA (pressure sensitive adhesive) 404 having a standard specification for thickness of approximately 50+/−10 μm (c) PET film 406 having a standard specification for thickness of approximately 188+/−5 μm (d) glass coating 408 having a standard specification for thickness of approximately 30 μm; (e) PSA 410 having a standard specification for thickness of 6 μm; and/or (f) protection film 412 having a standard specification for thickness of 50 μm. The adhesion strength for the screen corresponds in some embodiments to approximately 5+/−2 gf/inch. The pencil harness corresponds in some embodiments to approximately 9H. In some embodiments, the screen is implemented with a cross hatch cut. Transparency may be provided in the screen, e.g., at approximately greater than 92%. Haze may be implemented in some embodiments, e.g., at less than to equal to 1%.

The above-described nano screen in some embodiments corresponds to a glass-like harness coated screen protective film, e.g., of grade YIPI-188H. The screen may be configured with specific dimensions to fit the e-writer as well as having the capabilities in providing clarity to the naked eye. In addition, the screen thickness is selected to sustain laser precision engraving (as described in more detail below).

At step 306 of FIG. 3, the laser equipment is used to laser etch the screen material. Laser etching/engraving is non-contact method of engraving products made of nearly any material, including glass, polymers, and metals. In some embodiments, a laser marking process is employed where only a surface etching or color change occurs. Laser engraving is utilized when a depth of cut into the targeted surface is desired. Utilizing a much higher powered laser beam, the desired image is engraved into the surface by vaporizing material and thus cutting into the targeted surface. The method is implemented such that the laser passes over the image several times, until the desired depth has been achieved and engraved onto the surface permanently.

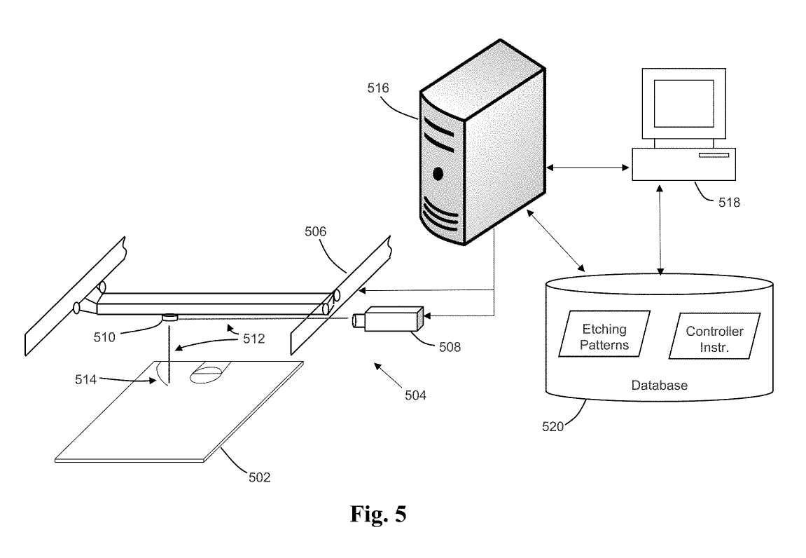

FIG. 5 illustrates this process of laser engraving/marking the screen material 502 according to some embodiments. A laser equipment controller 516 is operable to control the movement of laser device output 510 on the device mounting rack 506 of the laser equipment 504. The laser device output 510 exposes a laser beam 512 onto the surface of screen 502 in desired patterns 514 and time periods. Much like the movement of a print head in a printer, the laser device output 510 in a laser device translates in any X or Y direction to move to any desired location for engraving a pattern onto a surface. A sequence of mirrors and lenses may be used to direct the output of a laser device 508 (e.g., a CO2 laser) to the laser device output 510.

The controller 516 controls the direction, intensity, speed of movement, and spread of the laser beam 510 aimed at the screen 502. In some embodiments, a user station 518 is operable by a user to operate, control, and/or program the controller 516. A storage device 520 may be employed to hold the engraving/etching/marking patterns, as well as controller program instructions/scripts for operating the laser equipment 504.

In some embodiments, the following parameters may be employed to implement the laser engraving processing when patterning a basketball field lines onto the screen material: (1) Outer perimeter and half-court lines are 0.110″ wide, key circle is 0.080″ wide, all other linework is 0.075″ wide; (2) Surface etch, no measurable depth; (3) 1 pass; and (4) 13.0 minutes.

At step 308, the engraved screen material is aligned relative to the appropriate position/orientation for the tablet surface. Thereafter, at step 310, the overlay screen is affixed to the tablet surface. In some embodiments, the non-engraved side of the overlay screen comprises an adhesive that permits the overlay screen to adhere to the surface of the tablet.

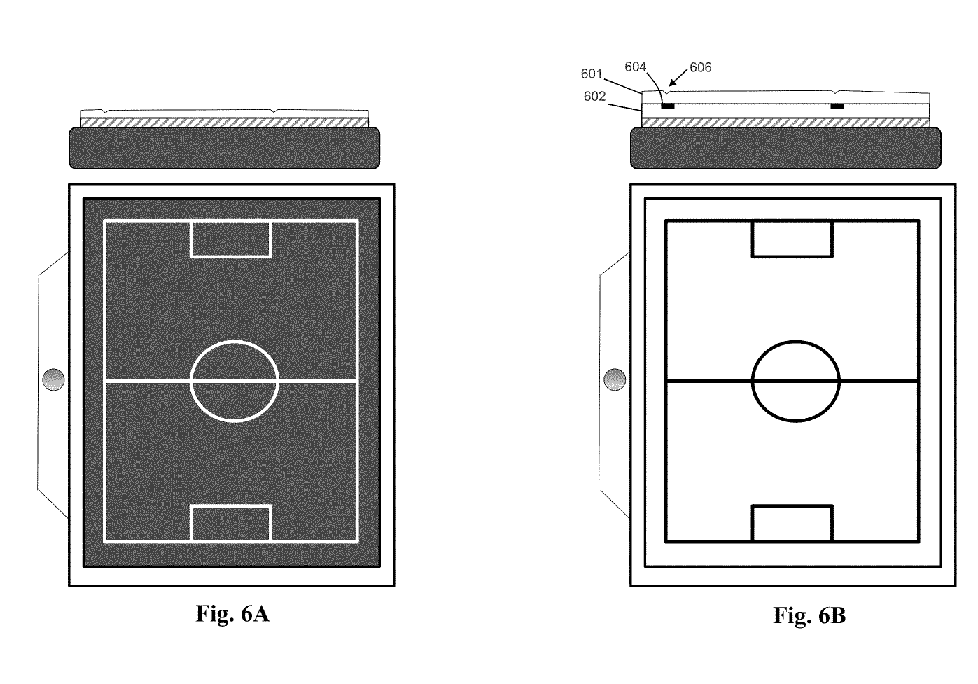

It is noted that in many known e-writer tablets, the writing surface has a dark coloration, e.g., as shown in FIG. 6A. This means that the laser-engraved portions of the overlay screen (which appears white or grayish in color) would be very visible on that dark surface.

However, it may also be desirable to implement coaching boards that have surfaces of other colors. For example, many users are very familiar and comfortable with the use of “whiteboards” that have a white writing surface, and hence it would be desirable for these users to be able to implement the e-writer coaching board with a white writing surface.

Different court colorations requires other screen colors. Therefore, as illustrated in FIG. 6B, one embodiment of the solution adds a transparent label layer 602 which may be configured to have any suitable color. For example, as shown in FIG. 6B, the label 602 is printed to have a white surface. In some embodiments, the label layer comprises a topcoated biaxially-oriented polypropylene film, e.g., one that is designed for semi-rigid applications and flexographic printing. In some cases, the material may comprise an acrylic adhesive for affixing to other surfaces.

The label layer 602 may include field lines 604 that are printed thereon to match any pattern associated with a desired sports endeavor. In some cases, the overlay screen layer 601 is applied over the label layer 602, to provide a protective coating and a smooth writing surface. The laser-engraved field lines 606, which may be white or gray in color, will stand out visibly when overlaid above the darker filed lines 604 that are printed onto the label layer 602.

Therefore, what has been described is an improved approach to implement a coaching board that provides numerous advantages. For example, the stylus does not require ink and serves the purpose of a marker to effect markings onto the tablet surface. Indeed, the pressure sensitive surface of the board also allows it to be written upon with the naked hand (fingers). In addition, the board can be easily cleared with a single touch (pulse) of the erasure button. This is why embodiments of the invention addresses the shortcomings of the conventional dry-erasure boards.

The coaching board can be implemented diagrams that resemble courts, fields and swimming pools so coaches can draw plays, position players and write temporary notes. The board can implement these diagrams without requiring paint on the screen, to avoid the problems of the paint that may cause the tablet to glitch and become non-operable. Instead, the overlay screen provides the field markings, while also serving to protect the underlying tablet screen.

What is claimed is:

1. A writer tablet, comprising:
a liquid crystal display (LCD) screen having a pressure sensitive surface that converts pressure into electrical signal that effects display substrate material on the LCD screen;
an overlay layer disposed over the LCD screen; and
one or more cut portions on the overlay layer, the one or more cut portions cut into surface portions of the overlay layer, the one or more cut portions shaped as sports-related field markings onto the overlay layer, wherein the one or more cut portions on the overlay layer are visually perceptible to the human eye.

2. The writer tablet of claim 1, wherein the overlay layer comprises a transparent tempered glass screen, and the one or more cut portions comprise engraved or etched portions of the overlay layer.

3. The writer tablet of claim 1, wherein one or more cut portions comprises a visually perceptible white or gray coloring, and the LCD screen comprises a dark or black colored surface.

4. The writer tablet of claim 1, further comprising a transparent label layer, wherein the transparent label layer comprises a different color from the LCD screen.

5. The writer tablet of claim 4, wherein the transparent label layer comprises a topcoated biaxially-oriented polypropylene film.

6. The writer tablet of claim 4, wherein the label layer comprises marked field lines.

7. The writer tablet of claim 1, wherein the overlay layer comprises: (a) a liner film; (b) a silicon pressure sensitive adhesive (PSA) layer; (c) a polyethylene terephthalate (PET) film; (d) a glass coating; and (e) a protection film.

8. The writer tablet of claim 7, wherein (a) the liner film corresponds to 70+/−2 μm thickness; (b) the PSA layer corresponds to 50+/−10 μm thickness; (c) the PET film corresponds to 188+/−5 μm thickness; (d) the glass coating corresponds to approximately 30 μm thickness; and (e) the protection film corresponds to approximately 50 μm thickness.

9. The writer tablet of claim 1, wherein the overlay layer corresponds to a transparency level of greater than 92%.

10. The writer tablet of claim 1, wherein the overlay layer corresponds to a haze level of less than or equal to 1%.

11. The writer table of claim 1, wherein the one or more cut portions on the overlay layer corresponds to a half-court line that is 0.110″ wide, a key circle that is 0.080″ wide, and other lines at 0.075″ wide.

12. A method to manufacture a writer tablet, comprising:
configuring a laser controller for marking locations on an overlay screen material disposed over a tablet surface; the for marking locations corresponding to sports-related field markings onto the overlay layer;
loading the overlay screen material;
operating the laser controller to manipulate a laser output device, the laser output device marking the overlay screen material at the marking locations;
aligning the overlay screen material having markings at the marking locations to a tablet surface; and
affixing the overlay screen material to the tablet surface.

13. The method of claim 12, wherein surface etching is performed to cut the overlay screen material at the marking locations.

14. The method of claim 12, wherein laser engraving is performed to cut the overlay screen material at the marking locations.

15. The method of claim 14, wherein the laser output device employs multiple passes to cut at a specified depth.

16. The method of claim 12, wherein the tablet surface comprises a transparent label layer.

17. The method of claim 16, wherein the transparent label layer comprises a different color from an LCD screen surface.

18. The method of claim 16, wherein the transparent label layer comprises a topcoated biaxially-oriented polypropylene film.
